(19) United States
(12) Patent Application Publication
(10) Pub. No.: US 2026/0301393 A1
(43) Pub. Date: Oct. 1, 2026

(54) HYBRID OPTICAL-ELECTRONIC SYSTEM FOR ON-EDGE MULTIMODAL AND MULTITASK VISUAL INTELLIGENCE

(71) Applicant: The Chinese University of Hong Kong, Shatin (CN)

(72) Inventors: Chaoran HUANG, Shatin (CN); Jiayong PENG, Shatin (CN)

(21) Appl. No.: 19/567,648

(22) Filed: Mar. 16, 2026

Related U.S. Application Data
(60) Provisional application No. 63/778,149, filed on Mar. 26, 2025.

(51) Int. Cl. G06V 10/80; G06V 10/42; G06V 10/44; G06V 10/82; G06V 20/17

(52) U.S. Cl. CPC G06V 10/806; G06V 10/42; G06V 10/44; G06V 10/82; G06V 20/17; G06V 2201/07

(57) ABSTRACT

A hybrid optical-electronic system for on-edge multimodal and multitask visual intelligence is provided. A computer-implemented method can include extracting, using an optical metasurface comprising a plurality of meta-atoms, global-image features and local-region features associated with an image. In some instances, the global-image features are extracted based on a first set of optical characteristics associated with the image, and the local-region features are extracted based on a second set of optical characteristics associated with the region of the image. The computer-implemented method can also include processing the global-image features and the local-region features using an electronic neural network to generate a set of machine-learning outputs. In some instances, the electronic neural network fuses the global-image features and the local-region features into one or more feature vectors, and processes the one or more feature vectors to simultaneously perform different types of image-processing operations, thereby generating the set of machine-learning outputs.

### CROSS-REFERENCES TO RELATED APPLICATIONS

This application claims benefit to U.S. Provisional Application No. 63/778,149, filed Mar. 26, 2025 and entitled “HYBRID OPTICAL-ELECTRONIC SYSTEM FOR ON-EDGE MULTIMODAL AND MULTITASK VISUAL INTELLIGENCE”, which is hereby incorporated by reference, in its entirety and for all purposes.

### FIELD

The present disclosure relates generally to processing images and videos using machine-learning models to perform various computer vision tasks. In one example, the systems and methods described herein may be used to implementing an optical metasurface to capture global and local information of images and videos, which are subsequently processed using an electronic neural network.

### SUMMARY

Disclosed embodiments may provide a hybrid optical-electronic system for on-edge multimodal and multitask visual intelligence. A computer-implemented method can include extracting, using an optical metasurface comprising a plurality of meta-atoms, global-image features associated with an image. In some instances, the global-image features are extracted based on a first set of optical characteristics associated with the image, in which the first set of optical characteristics are captured based on a first diffraction distance between the optical metasurface and an image sensor. The computer-implemented method can also include extracting, using the optical metasurface, local-region features associated a region of the image, in which the local-region features are extracted based on a second set of optical characteristics associated with the region of the image. In some instances, the second set of optical characteristics are captured based on a second diffraction distance between the optical metasurface and the image sensor, and the first diffraction distance is greater than the second diffraction distance. The computer-implemented method can also include accessing, using an image sensor, the global-image features of the image and the local-region features of the region of the image. The computer-implemented method can also include processing the global-image features and the local-region features using an electronic neural network to generate a set of machine-learning outputs. In some instances, the electronic neural network: (i) fuses the global-image features and the local-region features into one or more feature vectors; and (ii) processes the one or more feature vectors to simultaneously perform different types of image-processing operations, thereby generating the set of machine-learning outputs. The computer-implemented method can also include operating an embedded device based on the set of machine-learning outputs.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrative embodiments are described in detail below with reference to the following figures.

FIG. 1 illustrates an example schematic diagram for performing multi-task image analyses using a hybrid optical-electronic system, according to some embodiments.

FIG. 2 illustrates an example schematic diagram for using a MetaExtractor to extract local and global information associated with an image, according to some embodiments.

FIG. 3 shows comparative data of a hybrid optical-electronic system and other image-analysis techniques, according to some embodiments.

FIG. 4 shows a schematic diagram for performing joint training of an electronic neural network of a hybrid optical-electronic system, according to some embodiments.

FIG. 5 shows a schematic diagram and performance results of detecting objects using a hybrid optical-electronic system, according to some embodiments.

FIG. 6 shows a schematic diagram and performance results of semantic segmentation using a hybrid optical-electronic system, according to some embodiments.

FIG. 7 shows a schematic diagram and performance results of 3D reconstruction using a hybrid optical-electronic system, according to some embodiments.

FIG. 8 illustrates an example schematic diagram for performing multi-task video-stream analyses using a hybrid optical-electronic system, according to some embodiments.

FIG. 9 shows a schematic diagram and performance results of semantic segmentation of video data using the hybrid optical-electronic system, according to some embodiments.

FIG. 10 shows a schematic diagram and performance results of video understanding of video data using the hybrid optical-electronic system, according to some embodiments.

FIG. 11 illustrates an example pipeline and performance results of using the hybrid optical-electronic system to perform autonomous driving, according to some embodiments.

FIG. 12 illustrates an example process for performing multi-task image analyses using the hybrid optical-electronic system, according to some embodiments.

FIG. 13 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Artificial intelligence (AI) models have boosted many fields including computer vision, natural language processing, and AI-generated content. However, these existing AI models face difficulties in deploying on embedded devices for practical applications. Optical neural networks (ONNs) aim to overcome the hardware limitations and become suitable for time-energy sensitive tasks. But the ONNs are forced to exactly imitate the convolutional kernels in deep machine-learning models mathematically without fully exploiting the light propagation property. As a result, existing ONNs are confined to simple tasks (e.g., image classification), which is far behind real-world use cases.

To this end, the present techniques provide a hybrid optical-electronic system that not only facilitates multimodal and multitask computer visions including detection, segmentation, 3D reconstruction, and video understanding for the first time in optical computing, but also surpasses deep AI models in performance, speed, digital parameters, and energy consumptions. In some instances, the hybrid neural network includes a large-scale metasurface and a compact electrical backend. In optics, the metasurface can include 41 million meta-atoms in a single chip with size of 10 mm, achieving the largest modulation capability ever shown. The present techniques utilize the metasurface to implement a MetaExtractor configured to approximate RBF kernel and naturally extract local and global information at different diffraction distances based on the optical characteristics (e.g., light propagation characteristics) of the captured scene. For example, the metasurface first generates multi-channel (up to 256 channels) features that can then be linearly combined to single-channel local and global information during diffraction at light speed without energy consumptions.

The extracted local and global information can be versatile for multiple vision tasks, even if the metasurface is not dynamically configurable. The extracted local and global information can then be processed using a digital neural network. In some instances, the digital neural network is compact with only 87K digital parameters and 0.2 MB storage, which is 1000 times smaller than deep AI models and is significantly more resource-efficient in deploying on embedded devices. The FusionNet can include several optical-electronic fusion (OEF) blocks with each fusing the information in multiple resolution scales. The present techniques can be implemented for multimodal data (e.g., images, videos), further extending the application scopes of optical computing. With 2-3 orders of magnitude improvements over deep AI models in speed, digital parameters, and energy consumptions, the present techniques will bring earthshaking changes to the field such as autonomous driving, unmanned aerial vehicles, biomedicine inspection, even satellite surveillance and planetary exploration in the near future. We also envision our system being integrated into commercial cameras, mobile devices, and AR/VR glasses as a compact computing solution.

### I. Techniques for Performing on-Edge Multi-Task Image and Video Analyses Using a Hybrid Optical-Electronic System

### A. Overview

As described above, existing deep AI models can be implemented in several fields including computer vision, natural language processing, and AI-generated content. But they generally have millions or billions of digital parameters resulting in high cost of inference time and energy. Therefore, they can hardly be implemented in practical applications with time and energy restrictions, including autonomous driving, robotics, and virtual reality/augmented reality. In particular, a well-trained deep AI model operated on high-performance computing devices generally takes over 600 milliseconds of reaction time in autonomous driving. It is far behind the practical requirements that the reaction time is expected as short as 30 milliseconds in urban environments and less than 10 milliseconds for emergency maneuvers. In terms of energy consumption, the deep AI models commonly occupy hundreds of megabyte (MB) storages and require giga-floating point operations (Gflops). For example, the advanced segmentation model, SAM has over 630 million digital parameters and usually requires more than 1500 Gflops, 2 GB storage, and tens of joules for a single inference, which is impractical and almost impossible to be deployed on an embedded device.

The ONNs benefit from the inherent parallelism of light waves, and execute linear operations along the light propagation progress, reducing the computation time and energy consumptions to a great extent. Although ONNs are promising to get rid of the hardware limitations and suitable for time/energy-sensitive scenarios, they are currently confined to simple vision tasks (e.g., image classification) that is far beyond practical applications. In addition, the existing ONNs are forced to purely imitate the deep AI models mathematically. For example, the existing ONNs simulate the weights of convolutional kernels in CNNs, while ignoring the nature of light propagation. In addition, they have never borrowed the ideas from advanced deep learning methodologies. Specifically, for 2D integrated ONNs, they generally have a few thousands parameters to simulate convolutions, which cannot compete with deep models with millions or billions of parameters. For 3D free-space ONNs, they exploit the spatial parallelism in optics to significantly increase the parameters. However, these parameters cannot be precisely programmable for specific operations as be done in deep models, resulting in poor performance. Consequently, existing ONNs are only confined to simple vision tasks on standard benchmarks (e.g., image classification on Mnist or Fashion-Mnist datasets). However, even in simpler tasks, there are still large margins in performance degradation compared with existing deep models, thus hindering the applications for ONNs in real-world scenarios.

To address the above deficiencies, the present techniques provide a hybrid optical-electronic system that facilitates multimodal and multitask computer visions including detection, segmentation, 3D reconstruction, and video understanding for optical computing. The hybrid neural network surpasses deep AI models in performance, speed, digital parameters, and energy consumptions. In optics, different from the existing ONNs that are forced to simulate the weights of convolution kernels in deep models, the present techniques exploit the nature of light propagation to extract the local and global information at speed of light without energy consumptions. In electronics, a compact electrical backend can fuse the local and global information in a multi-scale manner stage by stage to improve the performance and enable multitask and multimodal capability.

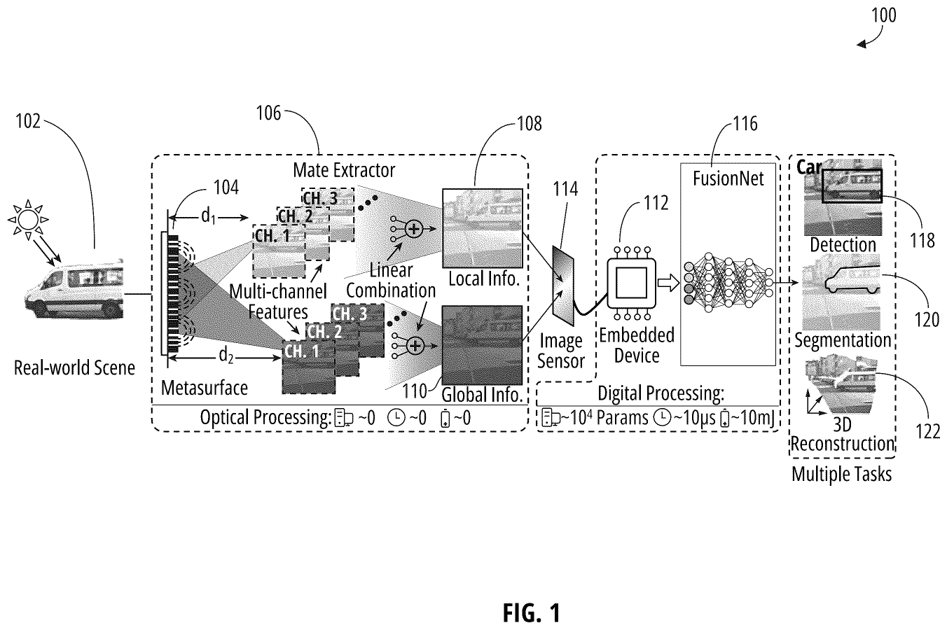

FIG. 1 illustrates an example schematic diagram 100 for performing multi-task image analyses using a hybrid optical-electronic system, according to some embodiments. As shown in FIG. 1, the hybrid optical-electronic system can capture optical characteristics of scene information 102 using a large-scale optical metasurface 104 with 41 million meta-atoms in a single chip with size of 10 mm. Each meta-atom of the metasurface 104 can be capable of modulating the phase, amplitude, and polarization of light at subwavelength scales, in which the modulation can be achieved in the light propagation progress at speed of light without energy consumptions. However, distinguishing from the existing metasurfaces that include meta-atoms that are explicitly designed and customized for certain kernel functions, the metasurface 104 is fabricated with phase and amplitude modulation coefficients that follow a Gaussian distribution. The Gaussian initialized kernels can approximate the RBF kernel, and the latter has been widely-used in scale-space representations, keypoint detection, and neural network-based feature extraction to yield robust and scale-invariant features across diverse domains. These kernels can model a variety of correlations from the images without any prior assumptions on the structures, thus is well-generalized to unseen data. In particular, the kernels of the metasurface 104 offers stable and robust representations in localized regions, making it particularly effective for tasks requiring precise localization, such as segmentation, detection, and reconstruction. As a result, the metasurface 104 achieves the largest modulation capability that enable complicated and comprehensive vision tasks.

The hybrid optical-electronic system can include a MetaExtractor 106 that can naturally extract local-region features 108 (alternatively referred herein as “local information 108”) and global-image features 110 (alternatively referred herein as “global information 110”) from light information captured by the metasurface 104. In some instances, the local information 108 and global information 110 are compressed from multi-channel features with linear combination in optics. The extracted local information 108 and global information 110 can be versatile for multiple vision tasks, without modifying geometrical characteristics of the meta-atoms of the metasurface 104. Stated differently, the local information 108 and global information 110 can be used to improve the performance and robustness of deep models in many fields, even without modifying the geometrical characteristics of the meta-atoms which are typically used to determine the weights of a neural network. In some instances, the local information 108 can indicate that a certain pixel tends to have similar values or structured patterns with its neighbors in a local area, while the global information 110 can indicate that the similar pixels can exist across the whole image in a global scale. In some instances, the deep models can extract local information 108 with receptive field smaller than the input image and extract global information 110 with receptive field as large as the input image. As described further herein, we can theoretically prove that the metasurface 104 of the hybrid optical-electronic system can extract the local information 108 and global information 110 at different diffraction distances. In particular, the light carrying the scene information 102, is modulated by the metasurface 104, generating multi-channel features that are linearly combined as highly compressed local information 108 and global information 110 in optics. In some instances, the hybrid optical-electronic system operates with incoherent light which is more appropriate for practical applications. Stated differently, the “effective field” (conceptually similar to the receptive field in CNNs) increases with the diffraction distance, and only pixels in the effective field can contribute to the output, thus providing local or global context. In addition, each pixel covers a number of meta-atoms (e.g., 12×8, 16×16, 32×32) due to the physical scales of the metasurface 104.

Thus, the meta-atoms in the same sub-location of different pixels constitute a group of new convolution kernels with same size as the effective field. And each convention kernel generates a one-channel feature during modulation. Therefore, the multi-channel (256 channels) features are generated and then linearly combined as highly compressed single-channel local information 108 and global information 110 during diffraction. As a result, the local information 108 and the global information 110 are naturally extracted at different diffraction distances purely based on the nature of light propagation at speed of light without energy consumptions. For example, the MetaExtractor 106 does not consume energy because the metasurface 104 can manipulate light passively through its nanostructure, using resonant effects, phase shifts, or polarization changes. Moreover, the extracted information can improve the performance by nearly 12% than the systems that do not use the configuration as described for the metasurface 104.

Once the MetaExtractor 106 extracts the local information 108 and the global information 110, an embedded device 112 uses an image sensor 114 to capture the local information 108 and the global information 110. Then, an electronic neural network stored in the embedded device 112 can be used to generate a target machine-learning output. For example, the neural network includes a FusionNet 116 that is configured to fuse the highly compressed local information 108 and global information 110 to generate intermediate output that can be processed for task-specific branches. The FusionNet 116 can thus generate intermediate outputs that can be used to perform multimodal and multitask computer visions and surpass deep models in performance, speed, parameter counts, and energy consumptions. In some instances, the FusionNet 116 is configured as a deep cascaded manner containing several optical-electronic fusion (OEF) blocks to fuse the information stage by stage. It hierarchically improves the non-linearity, extracts high-level features and improves the representation capabilities. In some instances, each OEF block of the FusionNet 116 takes local and global information (as well as edge maps) as input, and fuses them in multiple resolution scales to improve their robustness to scales, orientations, and shifts, which is crucial for multiple vision tasks. The highly compressed single-channel local information 108 and global information 110 not only condense the multi-channel features but also decrease the digital parameters of following networks with superior priors.

In some instances, the electronic neural network (e.g., FusionNet 116 and the downstream task branches) is compact with only 87K digital parameters and 0.4 MB storage that can be more easily deployed on embedded devices (e.g., the embedded device 112) while current deep AI models with millions or billions of parameters generally fail in deployment on these embedded devices. In addition, a joint training strategy can implemented to train neural networks with different task branches all together. As a result, the electronic neural network can simultaneously generate results for object detection 118, semantic segmentation 120, and 3D reconstruction 122 from one input image (e.g., the image of the scene information 102) and in one feed-forward process with performance improvements than individually training for each task. The training and inference operations of the electronic neural network is thus practical for applications like autonomous driving, since it significantly saves the time and energy compared with current deep models that sequentially generate results for each task. Moreover, the present techniques can handle not only static images but also video streams by exploiting the temporal correlations in frames, which further extends the application scopes for optical computing.

The object detection 118, semantic segmentation 120, 3D reconstruction 122, and video understanding (not shown in FIG. 1) can be used in various tasks such as autonomous driving pipeline. For instance, a prerequisite for autonomous driving operations can include segmenting the objects of interest (e.g., cars, pedestrians) from the backgrounds with fine-grained boundaries and precise localizations, computing the distance of such objects, and predicting following actions of the objects. The present techniques can perform the above tasks simultaneously, thereby achieving greater effectiveness for complicated tasks such as autonomous driving. It is worth mentioning that these complex tasks have never been achieved by existing ONNs that are confined to only simple and unique task (e.g., image classification).

By exploiting the advantages in both optics and electronics, the present techniques not only surpass the state-of-the-art deep AI models in accuracy and versatility, but also surpasses them in speed, flops, parameter counts, and energy consumptions. Compared with the deep AI models, the hybrid optical-electronic system is 3 orders of magnitude smaller in parameter counts, flops, and model storage, which is more feasible for real-world deployment (e.g., an embedded device). For example, the hybrid optical-electronic system can be implemented on an embedded device (e.g., NVIDIA Jetson Nano). Thus, the hybrid optical-electronic system can be adopted in robotics, autonomous driving, and Internet of Things (IoT) edge devices. We envision that the hybrid optical-electronic system can be integrated as a compact computing frontend in commercial cameras, mobile phones, and AR/VR glasses. With ~1000 times of improvements in speed, storage, and energy consumptions over the current AI models, the hybrid optical-electronic system will bring earthshaking changes to fields such as autonomous driving, unmanned aerial vehicles (UAVs), biomedicine inspection, satellite surveillance, and planetary exploration.

### B. Computing Environment

A conventional imaging and processing pipeline includes capturing the light encoding the scene information using the image sensor and then processed on the high-performance computing (HPC) cluster. Conventional deep AI models generally adopt specific network blocks to extract local and global features with massive channels and fuse these features with elaborate electrical backends. The overall digital processing thus commonly requires 10⁷ digital parameters with tens of milliseconds (ms) and joules (J). Such bulky AI models can be hardly deployed on embedded devices with limited storages and computation capabilities, hindering their usages in practical applications such as autonomous driving and UAVs.

By contrast, the present techniques fully exploit the nature of light propagation, which results in significantly decreasing the number of digital parameters and energy consumptions. As previously described in FIG. 1, the hybrid optical-electronic system includes the following components: (i) the MetaExtractor; (ii) a image sensor; (iii) the FusionNet; and (iv) one or more task branches (e.g., downstream machine-learning models that perform the corresponding tasks). The light encoding the scene information is first modulated by an optical metasurface extracting both local and global information. The local and global information are then captured by the image sensor and finally processed by the electronic neural network stored on an embedded device.

### 1. System Components

### a) Metasurface

Existing ONNs mainly require coherent light that can be hardly achieved in real world. By contrast, the hybrid optical-electronic system works with incoherent light which is more appropriate for practical applications. As previously described, the metasurface includes 41 million meta-atoms in a single 10 mm² chip, thus possessing the largest modulation capability that has never been shown before. Distinguishing from the existing metasurfaces that are explicitly designed for certain kernel functions, the metasurface of the hybrid optical-electronic system is fabricated with phase and amplitude modulation coefficients following a more general Gaussian distribution. The modulation is a linear operation (Hadamard product) between incident light and the coefficients of the metasurface generating features with multiple channels.

The metasurface can be created using different techniques that adopt Gaussian weight initialization of the meta-atoms. As an illustrative example, the metasurface is created using massive periodic unit cells. In some instances, each unit cell includes a 220-nm-thick silicon cylindrical nanodisk with a diameter that varies across different cells. The silicon nanodisk is deposited on a 2-μm-thick buried oxide layer on a 725-μm-thick silicon substrate. These unit cells are arranged in a square lattice in the two-dimensional plane. The period of the metasurface unit cell is 500 nm. Based on three-dimensional FDTD simulations, the optical phase and amplitude modulation coefficients of the unit cell for the incident light are obtained at various diameters under normal incidence. The simulation result indicates that the optical phase and amplitude of the incident light can be effectively manipulated by varying the diameter of the nanodisk. The fabricated metasurface comprises 6400×6400=41 million nanodisks in a 10 mm² chip. The diameter of every nanodisk is independently designed to realize the optical phase and amplitude modulation coefficients following a Gaussian sampling distribution.

In another example, the metasurface chip is fabricated based on a multiple-wafer-project (MPW) process offered by a commercial electron-beam-lithography-based silicon foundry. The fabrication process starts with a silicon-on-insulator (SOI) wafer, where the device layer thickness is 220 nm, the buffer oxide layer thickness is 2 μm, and the silicon substrate thickness is 725 μm. A layer of electron-sensitive resist is coated on the device layer of the wafer, followed by heating to strengthen the resist. After that, a 100 keV electron gun is used to define the nanodisk patterns of the metasurface. The wafer is then chemically developed, and the patterned resist remains on the substrate. Finally, an anisotropic RIE etching process is performed to transfer the pattern of the resist into the silicon device layer. The etching process will continue until the surface of the buffer oxide layer is exposed. The above examples are presented for illustrative purposes only, and various techniques of fabricating the metasurface or adjusting its geometrical characteristics can be contemplated by a person ordinarily skilled in the art.

Quantitative Phase Imaging (QPI) can be used to measure the reflective phase response of the metasurface. The system has a diffraction-limited spatial resolution of 665 nm and a field of view of 36×36 μm². With a total magnification of 200×, the system achieves a high pixel resolution of 60 nm, thus enabling a clear visualization of the phase modulation matrix.

An example implementation of the metasurface begins with an LED (light-emitting diode, LB-SPL-20 W) with a range of color temperature from 5000~8300 K. This LED is collimated by the built-in converging lens. The beam size of the LED is ~2 cm. The LED light is filtered with a 10-nm narrow band spectral filter (SF) at a center wavelength of 532 nm. Then, the filtered light passes through a 50/50 plane beam splitter (PBS). The light hits the surface of the SLM (spatial light modulator, Meadowlark Optics E19x12-400-800-HDM8). The SLM has a full-pixel resolution of 1920×1200, a pitch size of 12 μm, and a 12-bit modulation depth. A converging lens (CL) with a focal length of 10 cm is placed after the LP to transfer the reflected optical field at the surface of SLM onto the metasurface chip. Another 50/50 PBS is placed between the converging lens and the metasurface chip to ensure that the optical field will be projected under normal incidence on the chip. Both the phase and amplitude of the projected optical field are modulated by the meta-atoms of the metasurface.

In an alternative embodiment, an image system can be optionally used to correct one or more imperfections in the initial configuration of the metasurface. After that, an imaging system with two converging lenses (CLs) is used to transfer the modulated optical field onto the surface of the camera. The focal lengths of the two CLs are 10 cm and 15 cm. The purpose of the two CLs is to ease the effects of spherical imaging aberration. By adjusting the distance between the CLs and the metasurface chip and the distance between the CLs and the camera, the position of the imaging plane can be varied from the metasurface chip to capture “local information” and “global information”, respectively. At last, the image is captured by a CMOS camera (IRVI Contour IR Digital CMOS Camera) with a pixel resolution of 960×720.

### b) MetaExtractor

The MetaExtractor can generate the multi-channel features based on optical characteristics of the scene information. The multi-channel features can then be linearly combined in optics generating the highly compressed local and global information and finally captured by the image sensor. This optical processing is achieved at speed of light without energy consumption and completes a majority of computational load.

The MetaExtractor can thus be used as a powerful feature extractor and can naturally extract highly compressed local and global information at speed of light without energy consumptions. The incident light waves encoding the scene information, are first modulated by the metasurface and then captured by the image sensor at diffraction distance d. Specifically, the intensity value of a pixel p₀=x₀, y₀ in the captured image Iₒᵤₜ is the weighted summation of certain pixels around p₀ in the input image Iᵢₙ after modulation. Dᵢ is defined as the diffraction weight of Iᵢₙ(p₀+Δᵢ) in contributing to the Iₒᵤₜ(p₀) during diffraction, which is a function of the diffraction distance d. Δᵢ=Δxᵢ, Δyᵢ is the horizontal and vertical shifts to the pixel p₀. According to Electromagnetic Wave Theory and the Huygens-Fresnel Principle, the intensity value is inversely proportional to the square of the diffraction distance (I∝d12). Therefore, the ratio between the diffraction weight Dᵢ for pixel p₀+Δᵢ and the diffraction weight D₀ for pixel p₀ is derived as:

$$\frac{{D}_{i} ( d )}{{D}_{0} ( d )} \approx \frac{{d}^{2}}{{d}^{2} + {‖ {Δ}_{i} ‖}^{2}} \geq θ \cdot θ ∈ ( 0 , 1 )$$

is a threshold to filter out the pixels in Iᵢₙ without sufficient contributions to Iₒᵤₜ, and is set to 0.76 to keep as many as high contribution pixels. It is observed that for a certain diffraction distance d, the pixels with larger shifts to p₀ in Iᵢₙ have less contributions to the pixel p₀ in Iₒᵤₜ Thus, the range ∥Δ∥ is derived as:

$$‖ Δ ‖ ∈ ( d \cdot \sqrt{\frac{1}{θ} - 1} , L ) ] \qquad ( 1 )$$

where L=3.2 mm is the size of our metasurface. As a result, for a certain diffraction distance d, only pixels around p₀ within the range ∥Δ∥ in Iᵢₙ can contribute to the Iₒᵤₜ(p₀) This area is defined as “Effective Field”, which is conceptually similar to the “receptive field” in CNNs. The range ∥Δ∥ of the effective field grows with the diffraction distance thus providing different context information.

Existing techniques such as the classical CNNs are limited to extract local information since their receptive fields are generally one third or quarter of the input image, such as ResNet and AlexNet. Thus, new network architectures including Transformers, non-local mechanism, and oversized kernels, are designed to extract the global information with their receptive fields as large as the whole input image. Based on these techniques in CNNs, the effective field is set as one quarter of the input image for extracting the local information, while the whole input image for extracting the global information. Therefore, the local and global information are naturally extracted when diffraction distances d are set as 0.7 mm and 6 mm in our experimental setup, respectively.

In some instances, each pixel in Iᵢₙ covers 16×16 meta-atoms due to the physical scales of our metasurface. The metasurface facilitates a highly parallel Hadamard product between its coefficients and the input image during modulation, and the following diffraction is modeled as the linear combination.

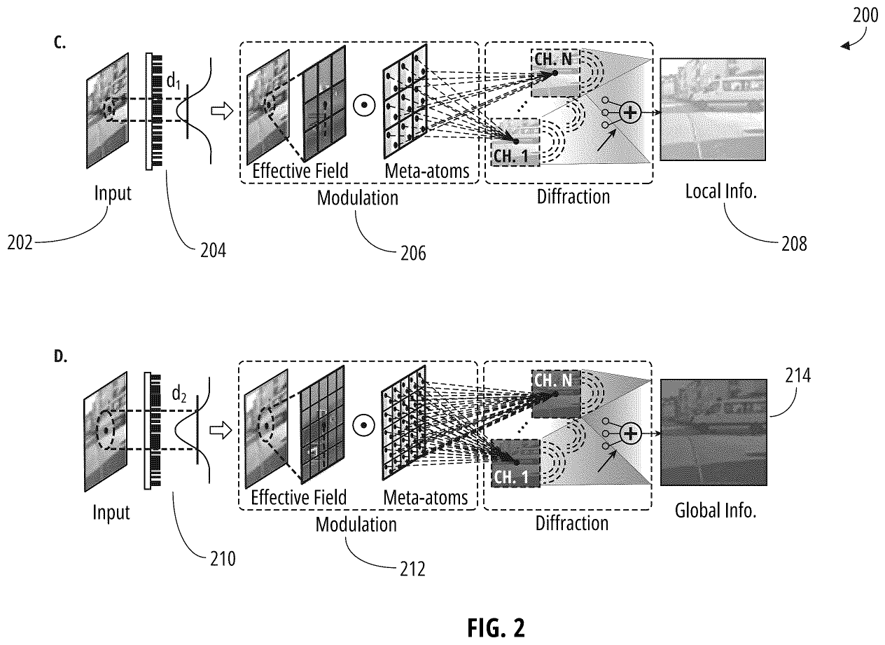

FIG. 2 illustrates an example schematic diagram 200 for using a MetaExtractor to extract local and global information associated with an image 202, according to some embodiments. For a certain diffraction distance (e.g., diffraction distance 204, diffraction distance 210), the meta-atoms in the same sub-location of different pixels constitute a group of new convolution kernels with same size. And each convolution kernel generates a one-channel feature during modulation (e.g., block 206 for local information, block 212 for global information). Thus, multi-channel (N=16×16 channels) features are generated and then linearly combined as highly compressed single-channel local information 206 and global information 214 during the diffraction.

More specifically, as shown in FIG. 2, the meta-atoms in the same sub-location of different pixels constitute a group of new convolution kernels with same kernel size as the range of effective field. And each convolution kernel generates a one-channel feature during modulation. Thus, multi-channel (16×16 channels) features are generated and then linearly combined as highly compressed single-channel local information 206 and global information 214 during the diffraction. This optical feature extraction process is modeled as:

$${I}_{out} = {\underbrace{{𝕂}_{1} \text{?} {I}_{in}}}_{channel 1} + {\underbrace{{𝕂}_{2} \text{?} {I}_{in}}}_{channel 2} + … + {\underbrace{{𝕂}_{256} \text{?} {I}_{in}}}_{channel 256} , \qquad ( 2 )$$

where [symbol] denotes the convolutional operation that is a Hadamard product followed by a summation. {K1, K2, . . . , K256} is the group of new convolution kernels, with its kernel size determined by the diffraction distance and its numbers determined by the physical scales of the metasurface. More kernel numbers means more powerful modeling capability and guarantees higher performance.

As a result, the highly compressed local information 206 and global information 214 are extracted at different diffraction distance by linearly combining the multi-channel features in optics. The massive number of modulation coefficients (41 million) improve the representation capabilities comparable to the deep AI models such as ResNet (~25 million) and SwinTransformer (~60 million). The range of effective field grows with the diffraction distance (e.g., diffraction distance 204 for the local information 206, diffraction distance 210 for the global information 214) thus naturally provide both local and global context. And the linear combination in optics is conceptually similar to the channel attention strategy in deep learning, which further condenses the features and improves their representation capabilities. More importantly, the optical feature extraction is achieved at speed of light without energy consumptions. It completes a majority of computational load thus reducing the burden of the following electrical backend.

### c) Electronic Neural Network

Electronic neural network can be a compact electrical backend tailored for the hybrid optical-electronic system to generate machine-learning outputs that can perform various computer vision tasks, such as object detection, semantic segmentation, 3D reconstruction, and video understanding. The electronic neural network can include FusionNet configured to fuse local and global information captured by the metasurface, such that the output of the FusionNet can be used by task-specific branches to perform the complex computer vision tasks. The local and global features in classical deep AI models are multi-channel and sparse, thus the electrical backends are designed with elaborate structures and massive digital parameters to fuse the information. In contrast, the local and global information from the MetaExtractor are single-channel and highly compressed. They not only provide sufficient priors, but also simplify the electrical backend by 1000 times in terms of digital parameters than the classical deep AI models.

Due to the efficiency of the MetaExtractor in generating local and global information, the electronic neural network can use approximately 87K digital parameters and 0.4 MB storage to generate targeted machine-learning outputs. Moreover, its small footprint can facilitate the electronic neural network to be deployed on an embedded device, which is very difficult and challenging for deep AI models with millions or billions of parameters. By attaching different tail branches to process intermediate outputs generated by the FusionNet, the electronic neural network can also facilitate multitask and multimodal computer visions such as object detection, semantic segmentation, 3D reconstruction, and even video understanding that have never been achieved before. The digital processing only takes tens of microseconds (μs) and millijoules (mJ), which is suitable for time/energy-sensitive applications.

Recent researches have also demonstrated that the channel attention strategy can condense the features and significantly decrease the digital parameters of the following networks. Specifically, the FusionNet is designed as a deep cascaded manner containing several optical-electronic fusion (OEF) blocks to fuse the information stage by stage. It not only preserves the localization priors but also improves the representation capabilities of features.

This hierarchical fusion strategy is efficient in extracting high-level features and improving the non-linearity, which has been widely adopted in computer vision tasks. The OEF block can be highly scalable that takes local and global information as well as the edge maps as input and fuses them in a multi-scale manner. The OEF block first downsamples the local information in spatial dimension and then extracts multi-scale features with the designed advanced convolutions (AC). Global information and edge maps are then downsampled to the corresponding scales with multiple dilation rates and then concatenated with the local features along channel dimensions. Finally, a residual connection is adopted to improve the training efficiency of the OEF block. The multi-scale fusion strategy in the OEF block improves the robustness of features to scales, orientations, and shifts, which is crucial and well-studied in computer vision tasks, such as detection, segmentation, and reconstruction. Both the hierarchical fusion strategy and the multi-scale fusion strategy are specifically designed for our highly compressed single-channel information.

As previously described, the electronic neural network is compact with less than 87K digital parameters and serves as a versatile backbone network that efficiently fuses the local and global information. With the metasurface, the combination of MetaExtractor and electronic neural network (including the FusionNet) acts as a hybrid optical-electronic system for optical computing. By attaching different tail branches, we achieve comprehensive computer vision tasks, such as object detection, semantic segmentation, 3D reconstruction, and video understanding.

In some instances, the electronic neural network can be trained using various training images and videos. For example, we conduct experiments on the widely-used real-world autonomous driving dataset Cityscapes and the real-world video dataset DAVIS. We adopt 2900 data samples for training and 200 data samples for testing from the Cityscapes. Each data sample has a local image, a global image, an edge map, ground-truth bounding boxes, a ground-truth segmentation mask, and a ground-truth depth map. The loss function for object detection is the combination of localization loss and confidence loss between ground-truth bounding boxes and predicted bounding boxes. The loss function for semantic segmentation is the Lovisz hinge loss between ground-truth segmentation masks and predicted segmentation masks. The loss function for the 3D reconstruction is the combination of L2 loss, gradient loss, and normal loss. The whole network is trained under the combination of object detection loss, semantic segmentation loss, and 3D reconstruction loss under the joint training strategy.

For DAVIS training dataset, we adopt 4940 frames for training and 183 frames for testing. The loss function for semantic segmentation is the Lovisz hinge loss between ground-truth segmentation masks and predicted segmentation masks. The loss function for video understanding is the cross-entropy loss between the ground-truth class labels and the predicted class labels.

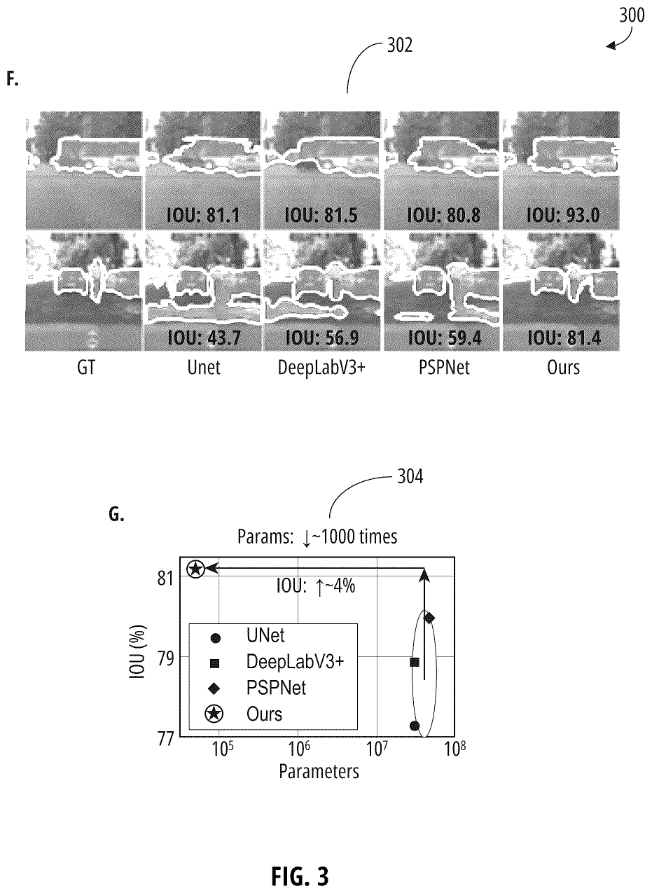

FIG. 3 shows comparative data 300 of the hybrid optical-electronic system and other image-analysis techniques, according to some embodiments. Based on the training configuration described above, FIG. 3 shows image-segmentation results 302 and a dot plot 304 based on the machine-learning outputs generated the hybrid optical-electronic system and current deep AI models. As shown in the dot plot 304, the number of parameters of the FusionNet can be 1000 times smaller in digital parameters, while the Intersection over Union (IOU) indicates 4% improvement over the deep AI models. The visual results shown by the image-segmentation results 302 also demonstrate the superiorities of the hybrid optical-electronic system by generating accurate segmentation masks with less artifacts than that from deep AI models.

### 2. Multitask Capability

In addition to the superiorities in single vision task over deep AI models, the hybrid optical-electronic system further enables multitask capability that simultaneously generates results for different tasks in one feed-forward process. For example, existing multitask machine-learning techniques individually train a corresponding machine-learning model (e.g., a neural network) for each task and sequentially generates results for them during inference.

However, the inference time and energy linearly increase with the number of tasks, which renders existing techniques as unacceptable in many real-world scenarios. For example, the detection, segmentation and 3D reconstruction are expected to be achieved in few milliseconds for autonomous cars, which is difficult to achieve using existing multitask learning techniques. To address the above deficiency, we propose the joint training strategy to train the network that simultaneously generates results for object detection, semantic segmentation, and 3D reconstruction from one input image in one feed-forward process.

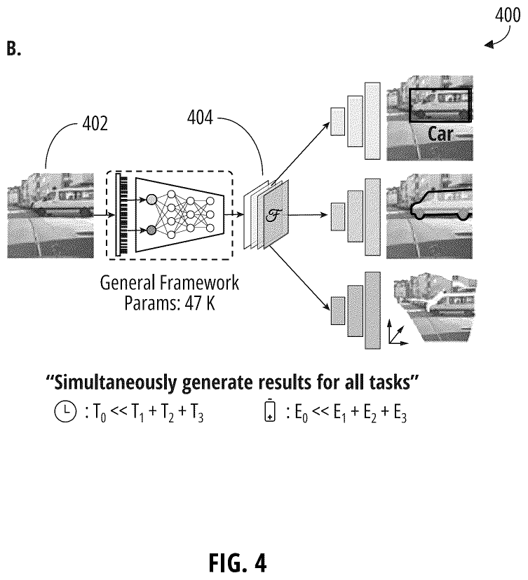

FIG. 4 shows a schematic diagram for performing joint training of a hybrid optical-electronic neural network (FusionNet), according to some embodiments. As shown in FIG. 4, the input image 402 is processed with our general framework generating the shared features F 404, and then are fed into different tail branches. In some instances, each tail branch corresponds to a separate machine-learning model that can be trained to perform a particular task (e.g., image segmentation). The overall digital parameters are trained under conjunction with different tasks. Compared with the individually training for each task, the joint training not only decreases the digital parameters, flops, energy consumptions, and inference time by around 60%, but also improves the performance for each task.

The hybrid optical-electronic system thus facilitates complicated and comprehensive vision tasks including object detection, semantic segmentation, and 3D reconstruction, that have never been achieved by current ONNs. By fully exploiting the advantages in both optics and electronics, the hybrid optical-electronic system surpasses deep AI models in performance, with 100~1000 times of improvements in digital parameters, flops, and energy consumptions. Furthermore, the joint training strategy enables the hybrid optical-electronic system simultaneously generates results for object detection, semantic segmentation, and 3D reconstruction from one input image in one feed-forward process. It not only improves the performance for each task, but also decreases the digital parameters, flops, energy consumptions, and inference time by several orders of magnitude. Thus, the hybrid optical-electronic system is more practical for time/energy-sensitive applications and is much easier for deploying on embedded devices, for example the autonomous driving, than the deep AI models.

We demonstrate the multitask capability of the hybrid optical-electronic system with a practical application: the autonomous driving. The object detection, semantic segmentation, 3D reconstruction, and video understanding are very important components in the autonomous driving pipeline. Since detecting cars and pedestrians, segmenting them from the backgrounds, computing the distance, and predicting their following actions are the prerequisites before making decisions for cars. The comparisons are made with the cutting-edge deep AI models that are widely-used in various scenarios, including FasterRCNN, MaskRCNN, and RetinaNet for object detection; Unet, PSPNet, and DeepLabV3+ for semantic segmentation; FPN, FastNet, and FuseNet for 3D reconstruction. The experiments are conducted on widely-used real-world autonomous driving dataset Cityscapes.

### a) Object Detection

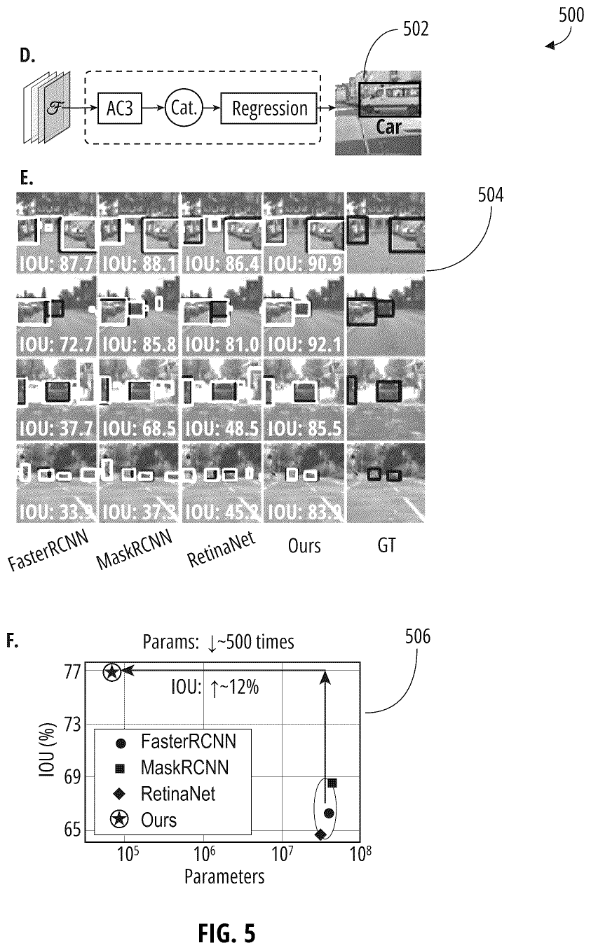

The object detection is to detect cars and persons from the input images, which is an important front-end processing in the autonomous driving pipeline. FIG. 5 shows a schematic diagram and performance results 500 of detecting objects using the hybrid optical-electronic system, according to some embodiments. As shown in FIG. 5, the schematic diagram 502 shows a process for performing object detection using the hybrid optical-electronic system, in which bounding boxes are regressed from the shared features. The set of images 504 show visual comparisons with the deep AI models, in which the ground-truth bounding boxes are labeled in red. As shown in the images 504, our framework predicts more accurate bounding boxes with much smaller shifts to the ground truth, whereas the baseline methods predict more false alarms. In addition, our framework is more sensitive to small objects and more robust in low-light and noisy conditions that are generally regarded as hard cases in object detection.

The quantitative comparisons of IOU averaged on overall 200 test samples are shown in the dot plot 506. We achieve the highest IOU score (77.0%) with more than 12% improvements over the baseline deep models: FasterRCNN (66.2%), MaskerRCNN (68.5%), and RetinaNet (64.5%). It is also worth mentioning that our framework is about 500, 400, and 120 times smaller than the deep models in digital parameters, flops, and energy consumptions, respectively. It further demonstrates the superiorities of the local and global information extracted from the metasurface and the effectiveness of our FusionNet in performance and digital parameters.

### b) Semantic Segmentation

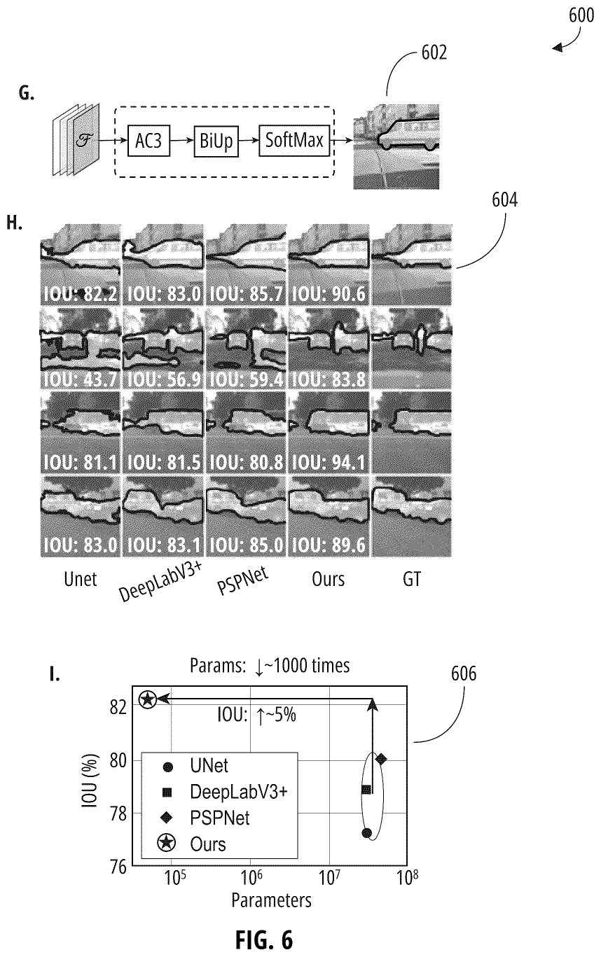

FIG. 6 shows a schematic diagram and performance results 600 of semantic segmentation using the hybrid optical-electronic system, according to some embodiments. The semantic segmentation is to segment objects from the input images with fine-grained boundaries and precise localizations. Our segmentation branch is shown in schematic diagram 602, where segmentation masks are predicted from the shared features. The visual comparisons with the deep AI models are shown in sets of images 604, in which our framework predicts more accurate results with less artifacts than that from the deep models. In particular, our framework is more robust in complicated scenarios, for example the second and the fourth scene where objects are so close to the backgrounds in appearance that deep models generally fail to predict reliable results.

In addition, as shown in the dot plot 606, the hybrid optical-electronic system also achieves the highest IOU (82.3%) with about 5% improvements over the baseline deep models: Unet (77.3%), DeepLabV3+(78.9%), and PSPNet (80.0%). Our framework is nearly 1000, 300, and 35 times smaller than the deep models in digital parameters, flops, and energy consumptions, respectively, which is very suitable for deploying on embedded devices.

### c) 3D Reconstruction

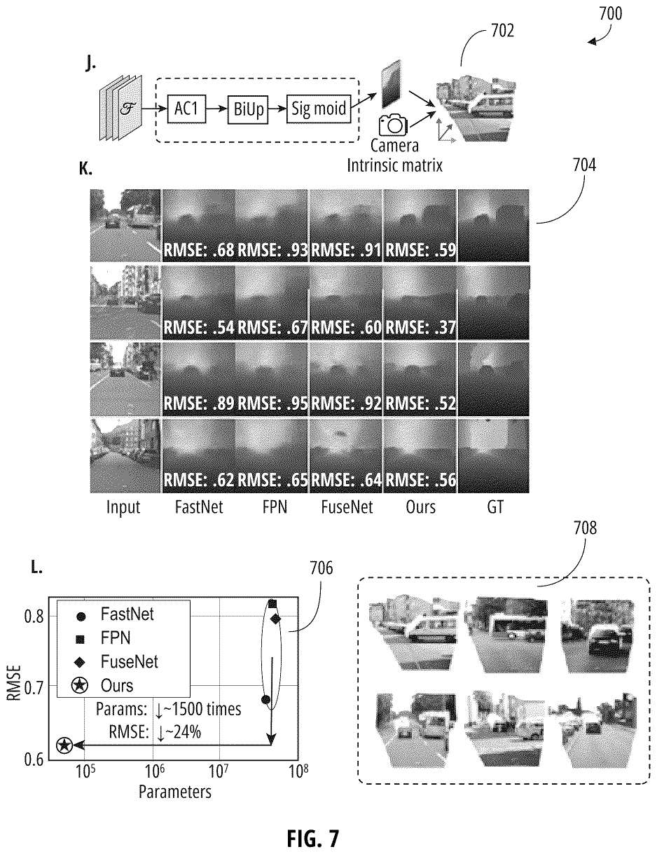

FIG. 7 shows a schematic diagram and performance results 700 of 3D reconstruction using the hybrid optical-electronic system, according to some embodiments. The 3D reconstruction is to recover 3D geometries of the scene from the input 2D image, which is useful for distance sensing and route planning in autonomous driving. We follow the pipeline of first predicting depth information from single 2D image and then mapping it to the 3D Cartesian coordinate for recovering geometries.

The schematic diagram shows the 3D reconstruction branch of the electronic neural network, in which the depth maps are first predicted from the shared features, and then are projected to retrieve 3D geometries with consideration of camera intrinsic matrix. The visual comparisons with the deep AI models are shown in a set of images 702, with each labeled with the RMSE (Root Mean Square Error). As shown in the images 702, our framework predicts more accurate depth maps with sharper edges, while the deep AI models predict noisy results with more artifacts. In addition, we are robust in occlusions and specular reflections (e.g., the first and the third scene) that are admittedly hard cases in depth prediction.

Moreover, the quantitative results shown in dot plot 706 also demonstrate the superiorities of our framework (0.62) with about 24% improvements over the deep models: FastNet (0.68), FPN (0.81), and FuseNet (0.79). Note that, our framework is nearly 1500, 500, and 140 times smaller than the deep models in digital parameters, flops, and energy consumptions, respectively. The 3D geometries are recovered directly from the depth maps companied with the intrinsic matrix of the camera, shown in images 708. The reconstructed 3D geometries are clean with less noise, presenting a more realistic visualization.

### 3. Multimodal Capability

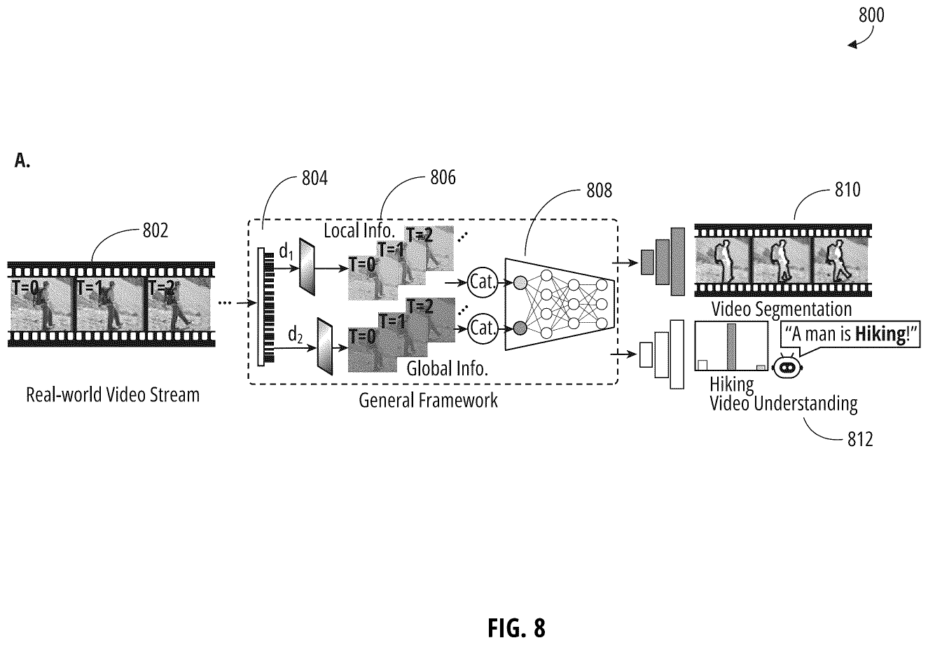

The hybrid optical-electronic system has the multimodal capability that can deal with not only the static images but also the video streams. For example, for autonomous driving, video analysis can facilitate prediction of present and near-future actions of cars and pedestrians. FIG. 8 illustrates an example schematic diagram for performing multi-task video-stream analyses using the hybrid optical-electronic system, according to some embodiments. As shown in FIG. 8. the real-world dynamic scene 802 is first processed by the metasurface 804 extracting the highly compressed local and global information 806 for each time stamp. They are then concatenated along temporal dimension and fed into the FusionNet 808, where the temporal information is fully exploited. We demonstrate the multimodal capability of the hybrid optical-electronic system with video segmentation 810 and video understanding 812 that have never been achieved by current ONNs.

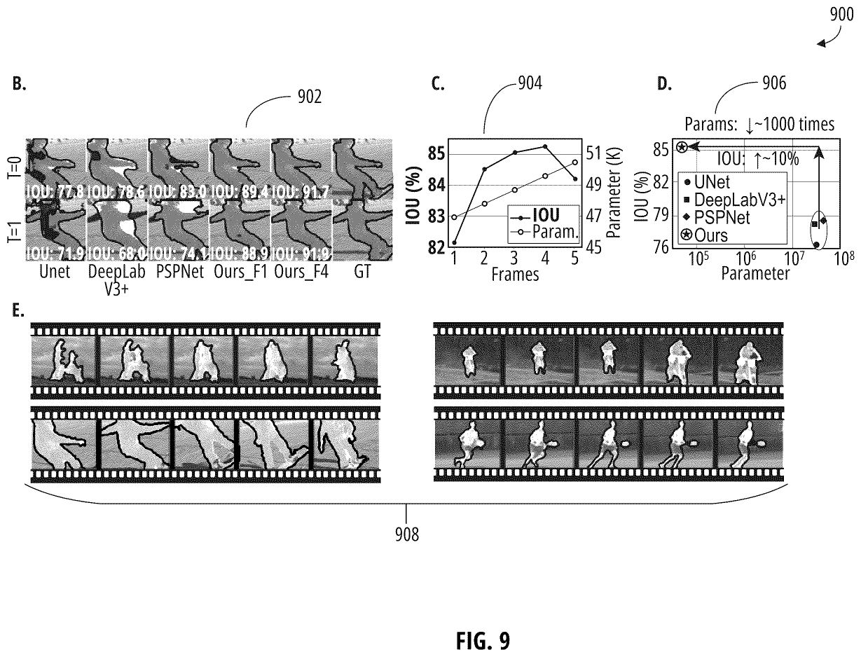

FIG. 9 shows a schematic diagram and performance results of semantic segmentation of video data using the hybrid optical-electronic system, according to some embodiments. The visual comparisons of our framework and cutting-edge deep AI models on two time stamps in semantic segmentation are shown in a set of images 902. As shown in the image 902, our framework (Ours F1 and Ours F4) predicts more accurate segmentation masks while deep AI models generally fail in complicated backgrounds. Moreover, the exploitation of temporal information also boosts the performance, as shown in graph 904. In particular, the IOU score gradually improves with more video frames being exploited, achieving the highest IOU (85.3%) when four adjacent frames are considered. And it decreases for five more frames since temporal alignment in our current framework is becoming significantly difficult in handling large motions and occlusions for dense prediction tasks, such as segmentation and depth estimation.

As a result, we achieve the highest IOU with nearly 10% improvements over deep AI models: Unet (76.1%), DeepLabV3+ (78.1%), and PSPNet (78.5%), even with 1000 times smaller in digital parameters, shown in the dot plot 906. The visual results on several video samples of our framework with four adjacent frames are shown in video frames 908, further demonstrating the superiorities of our framework.

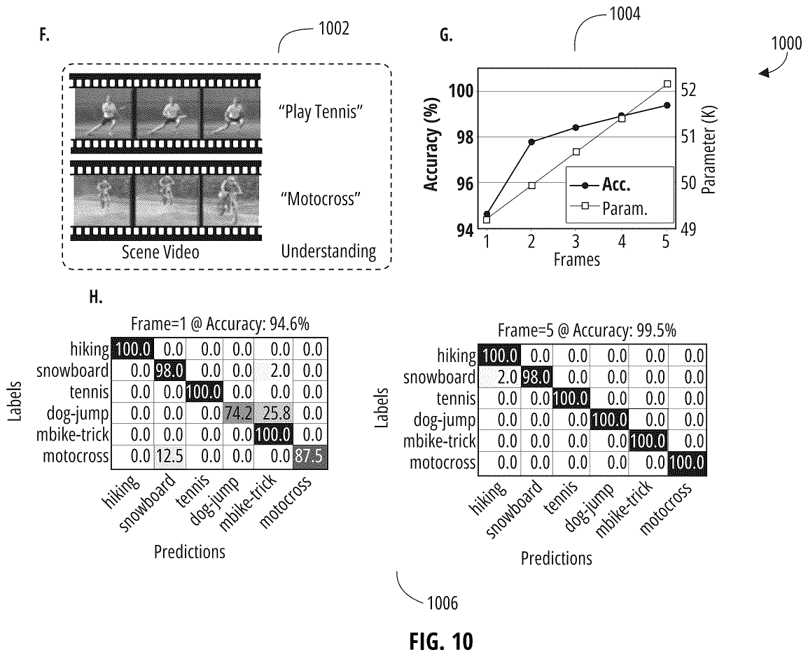

By exploiting the temporal information, the video content can be better understood, which is beneficial to the applications such as video recommendation and video generation. FIG. 10 shows a schematic diagram and performance results of video understanding of video data using the hybrid optical-electronic system, according to some embodiments. As shown in the graph 1004, the video understanding accuracy increases with the number of the frames, demonstrating that more input frames helps to better understand the video content. The confusion matrixes 1006 show different frame numbers on six video scenarios. The single input frame (no temporal information is exploited) leads the accuracy of 94.6%, while five input frames leads the accuracy of 99.5%, which further demonstrates the superiorities of our framework in exploiting the temporal information. The video understanding results 1002 are shown with input videos and the generated understanding results.

As demonstrated above, our framework is capable of understanding video streams, which facilitates autonomous cars to predict the following actions of cars and pedestrians. The exploitation of the temporal information further improves the performance of the hybrid optical-electronic system and broadens its application scope. For example, our framework can be used for video generation and video editing with huge superiorities in speed, flops, energy consumptions, and performance over current deep AI models.

### 4. Example Implementations

With 2 and 3 orders of magnitude improvements in digital parameters, flops, and energy consumptions over the deep AI models, the hybrid optical-electronic system is thus much more easily to be deployed in embedded devices for practical applications.

As an illustrative example, our framework can be integrated into a compact prototype containing a metasurface, a CCD/CMOS sensor, and an embedded device in the future. The prototype can be carried by any time/energy-sensitive platforms such as autonomous cars, UAVs, and even satellites, enabling real-time data capturing and processing on board. For example, with the capabilities of multitask and multimodal processing, the prototype can simultaneously detect the cars, pedestrians, and buildings, segment them from the complicated backgrounds with fine-grained boundaries, and compute their distances at extremely high processing speed for various scenarios. These prerequisites are fully considered all together when making decisions for autonomous cars, UAVs or satellites. In order to demonstrate the superiorities of our framework in real-world applications, we deploy our FusionNet on the NVIDIA Jetson Nano. It is a compact and energy-efficient and versatile AI computing platform, and is widely adopted in robotics, autonomous driving, and IoT edge devices. It offers up to 472 GFLOPS (giga-floating point operations per second) of computational performance, 4 GB RAM, and 5 W power consumptions. However, it still cannot support current high-performance large AI models with millions or even billions of digital parameters and requiring dozens of GB RAM.

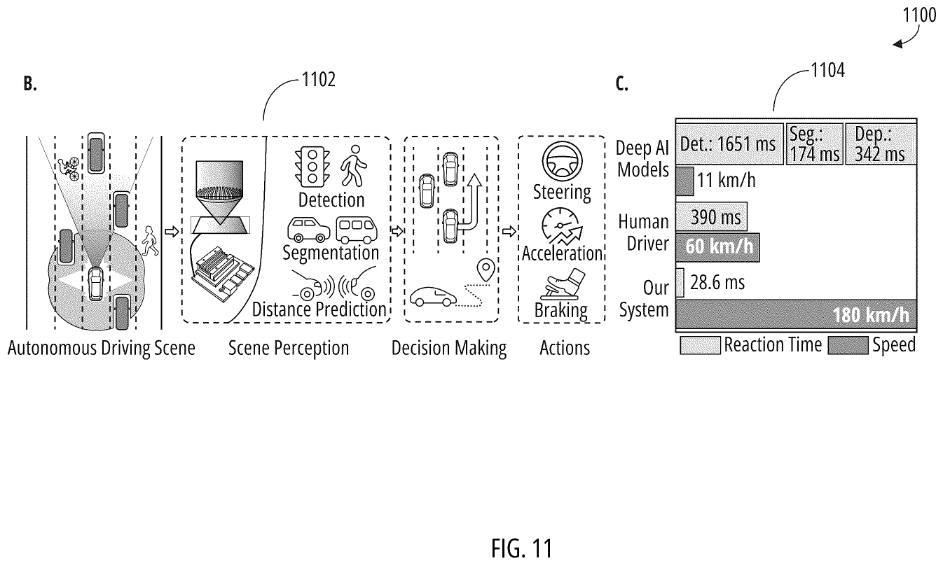

In another illustrative example, the hybrid optical-electronic system can be implemented into an autonomous driving pipeline. FIG. 11 illustrates an example pipeline and performance results 1100 of using the hybrid optical-electronic system to perform autonomous driving, according to some embodiments. As shown in the schematic diagram 1102, a self-driving car monitors the surroundings with sensors including cameras and LiDARs, detects, segments cars and pedestrians, and predicts their distances, denoting as scene perception. The scene perception provides prerequisites for the following decision making and finally taking actions. The autonomous driving is classified to six levels (from Level 0 to Level 5), and current autonomous car are mainly categorized to Level 2 limited by their reaction time.

For example, the bar graph 1104 shows that human drivers typically require about 390 to 600 milliseconds to detect and react to road hazards. As further shown in the bar graph 1104, deep AI models tested on the NVIDIA Jetson Nano take more than 2100 milliseconds for reaction, including object detection (1651 ms), semantic segmentation (174 ms), and depth prediction (342 ms). However, the hybrid optical-electronic system can greatly speed up the scene perception by simultaneously completing detection, segmentation, and distance prediction in a pure-vision architecture without redundant sensor fusion with LiDARs. The hybrid optical-electronic system takes only 28.6 milliseconds of reaction time, which is about 15 times and 75 times shorter than human drivers and deep AI models. The shorter the reaction time is, the faster and the safer a car can move. To be specific, if a human drives a car at speed of 60 km/h, he can react to road hazards in 390 to 600 ms, in the meantime the car moves 6.5 to 10 meters. With the same reaction distance, the deep AI models on the NVIDIA Jetson Nano can support a maximal speed of only 11 km/h, which is even slower than riding a bike thus is unpractical for real-world scenarios.

However, the hybrid optical-electronic system supports a maximal speed over 180 km/h, which facilitates new applications such as autonomous racing and high-density urban traffic flow. Stated differently, a human driver can react within 6.5 meters, and deep AI models react within 36 meters. While the hybrid optical-electronic system can react within 0.5 meters, which greatly decreases the collision risks and improves the safety of cars and passengers. Therefore, the hybrid optical-electronic system is promising to unlock higher level autonomous driving (e.g., Level 5) and is suitable for urban environments. Moreover, the hybrid optical-electronic system is compact with less than 0.4 MB (even with detection, segmentation, and 3D reconstruction branches) in model size, while deep AI models usually have over 100 MB in model size.

The hybrid optical-neural system can be very beneficial and advantageous for real-world applications, since many embedded devices have such limited storages, RAM, and computation capability that prevent deep AI models from being deployed. Benefit from the small model size, the digital parameters of our framework can be updated via the internet to keep the best performance on different scenarios all the time in the future. As a result, the hybrid optical-electronic system enables much higher driving speed and shorter reaction time and distance compared with human drivers even on a computation limited device. By contrast, the deep AI models cannot support practical autonomous driving on the same device. We believe that the hybrid optical-electronic system is a promising solution for high speed and safety autonomous driving in various scenarios.

### C. Methods

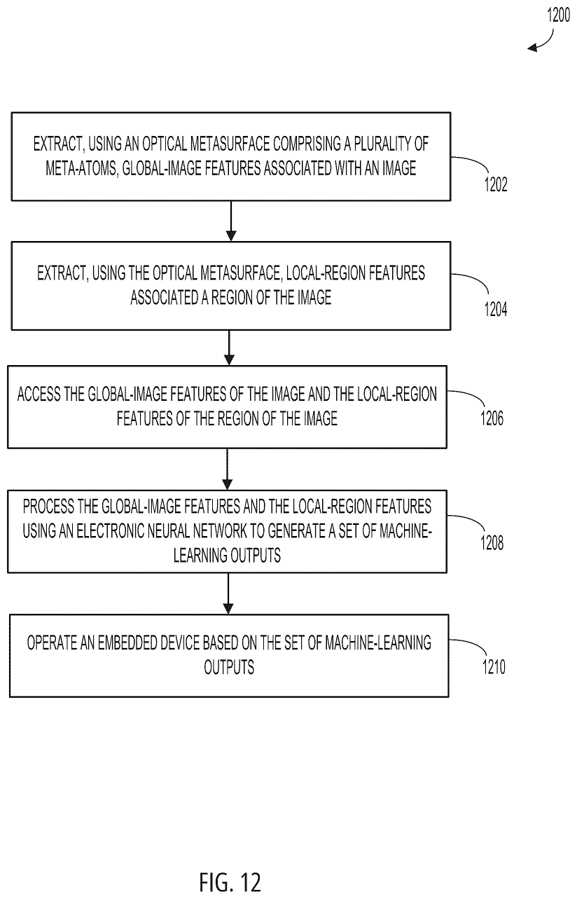

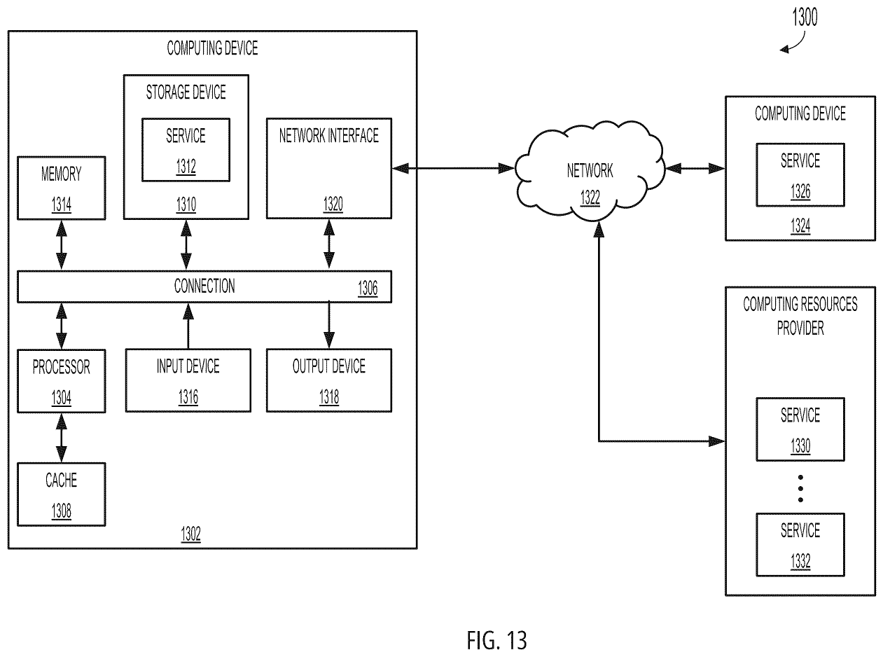

FIG. 12 illustrates an example process for performing multi-task image analyses using the hybrid optical-electronic system, according to some embodiments. For illustrative purposes, the process 1200 is described with reference to the components illustrated in FIGS. 1-7, though other implementations are possible. For example, the program code for the hybrid optical-electronic system of FIG. 1, is executed by one or more processing devices to cause a server system (e.g., the computing device 1302 of FIG. 13) to perform one or more operations described herein.

At step 1202, the hybrid optical-electronic system extracts, using an optical metasurface comprising a plurality of meta-atoms, global-image features associated with an image. For example, a large-scale optical metasurface with 41 million meta-atoms in a 10 mm² chip to have the largest modulation capability. Instead of mimicking the specific kernel functions as done in existing optical neural networks (ONNs), the optical metasurface is fabricated with phase and amplitude modulation coefficients following a more general Gaussian distribution.

In some instances, the global-image features are extracted based on a first set of optical characteristics associated with the image. In some instances, the first set of optical characteristics are captured based on a first diffraction distance between the optical metasurface and a camera. In some instances, the optical metasurface is fabricated with phase and amplitude modulation coefficients that are in accordance with a Gaussian distribution. The image corresponds to a video frame of a plurality of video frames.

At step 1204, the hybrid optical-electronic system extracts, using the optical metasurface, local-region features associated a region of the image. In some instances, the local-region features are extracted based on a second set of optical characteristics associated with the region of the image. In some instances, the second set of optical characteristics are captured based on a second diffraction distance between the optical metasurface and the camera. In some instances, the first diffraction distance is greater than the second diffraction distance.

In some instances, the hybrid optical-electronic system extracts the local-region features by generating multi-channel features of the image based on the second set of optical characteristics. In some instances, the multi-channel features include a plurality of individual-channel features. In some instances, each individual-channel feature is captured using a subset of the plurality of meta-atoms of the optical metasurface. The hybrid optical-electronic system can perform a linear combination of the multi-channel features to extract the local-region features of the image.

As a result, the optical metasurface can be configured to naturally extract local and global features at different diffraction distances purely based on the nature of light propagation. For example, the metasurface naturally generates multi-channel features that are then linearly combined as highly-compressed single-channel local and global information during diffraction. As demonstrated above, the local and global information are versatile for multiple vision tasks without dynamically configuring the optical metasurface. The above optical feature extraction process is achieved purely based on the properties of light propagation at speed of light without energy consumptions, and it completes a majority of computational load for the ensuing steps of FIG. 12.

At step 1206, the hybrid optical-electronic system accesses, using an image sensor, the global-image features of the image and the local-region features of the region of the image.

At step 1208, the hybrid optical-electronic system processes the global-image features and the local-region features using the electronic neural network to generate a set of machine-learning outputs. In some instances, the electronic neural network: (i) fuses the global-image features and the local-region features into one or more feature vectors; and (ii) processes the one or more feature vectors to simultaneously perform different types of image-processing operations, thereby generating the set of machine-learning outputs. For example, the hybrid optical-electronic system processes the compressed set of features using the electronic neural network to generate the set of machine-learning outputs. The electronic neural network includes less than 80,000 machine-learning parameters. In some instances, a file size of the electronic neural network is less than 0.4 MB.

In some instances, the different types of image-processing operations include object detection within the image, semantic segmentation of the image, and/or 3D reconstruction of the image. In some instances, the electronic neural network was trained to generate the set of machine-learning outputs without modifying geometrical characteristics of the plurality of meta-atoms of the optical metasurface.

As a result, the electronic neural network effectively fuses the highly compressed local and global information extracted by the optical metasurface. The electronic neural network facilitates multiple complicated vision tasks as well as surpasses deep models in performance, speed, parameter counts, and energy consumptions. In some instances, with the joint training techniques, the electronic neural network can be trained to simultaneously generates results for object detection, semantic segmentation, and 3D reconstruction from one input image and in one feed-forward process. The joint training technique not only improves the performance for each image-processing operation, but also decreases the digital parameters, flops, energy consumptions, and inference time by few orders of magnitude, which is practical for time/energy-sensitive applications (e.g., autonomous driving).

The hybrid electronic neural network can also process video streams. By exploiting the temporal information, the electronic neural network can understand the video content, further extending its application scopes.

At step 1210, the hybrid optical-electronic system operates an embedded device based on the set of machine-learning outputs. In some instances, the embedded device includes an autonomous piloting system for an automobile or an unmanned aerial vehicle (UAV), and operating the embedded device includes performing autonomous driving. Additionally or alternatively, the embedded device includes an Internet of Things (IoT) edge device, and operating the embedded device includes detecting one or more objects depicted in the image. The hybrid optical-electronic system can thus be deployed on the embedded device, achieving hundreds of times improvements in processing speed, model size, and energy consumptions over deep AI models. In addition, the hybrid optical-electronic system can process features captured from incoherent light, which is more appropriate for practical fields, such as autonomous cars, UAVs, and satellites. Process 1200 terminates thereafter.

Accordingly, the hybrid optical-electronic system can not only facilitate multimodal and multitask computer visions including detection, segmentation, 3D reconstruction, and video understanding for the first time in optical computing, but also surpasses deep AI models in performance, speed, digital parameters, and energy consumptions.

In some instances, the optical metasurface can be integrated as a computing frontend in many devices such as commercial cameras, mobile phones, and VR/AR glasses. Its compactness as well as the light speed processing capability without energy consumptions can bring significant changes to many applications. For example, current AI models operated on high-performance computing devices generally takes more than 600 milliseconds and 10 meters of reaction time and distance before making decisions for autonomous cars. By contrast, the hybrid optical-electronic system can greatly reduce the reaction time and distance to 28.9 milliseconds and less than 0.5 meters. Such improvement can increase the safety for dynamic hazards, decrease the collision risks, and facilitating autonomous racing. It is a promising solution for high speed and safety autonomous driving in both urban and highway environments.

In addition, the hybrid optical-electronic system can extend the service life for energy-sensitive equipment such as UAVs and satellites. Currently, the data capturing and digital processing generally takes more than 50% total power budget in a UAV or a CubeSat. However, the hybrid optical-electronic system reduces the energy consumptions by over 100 times. The significant reduction can increase their flying distance or service life by over 200%, significantly helping them to complete more surveillance and explorations.

### II. Example Systems

FIG. 13 illustrates a computing system architecture 1300, including various components in electrical communication with each other, in accordance with some embodiments. The example computing system architecture 1300 illustrated in FIG. 13 includes a computing device 1302, which has various components in electrical communication with each other using a connection 1306, such as a bus, in accordance with some implementations. The example computing system architecture 1300 includes a processing unit 1304 that is in electrical communication with various system components, using the connection 1306, and including the system memory 1314. In some embodiments, the system memory 1314 includes read-only memory (ROM), random-access memory (RAM), and other such memory technologies including, but not limited to, those described herein. In some embodiments, the example computing system architecture 1300 includes a cache 1308 of high-speed memory connected directly with, in close proximity to, or integrated as part of the processor 1304. The system architecture 1300 can copy data from the memory 1314 and/or the storage device 1310 to the cache 1308 for quick access by the processor 1304. In this way, the cache 1308 can provide a performance boost that decreases or eliminates processor delays in the processor 1304 due to waiting for data. Using modules, methods and services such as those described herein, the processor 1304 can be configured to perform various actions. In some embodiments, the cache 1308 may include multiple types of cache including, for example, level one (L1) and level two (L2) cache. The memory 1314 may be referred to herein as system memory or computer system memory. The memory 1314 may include, at various times, elements of an operating system, one or more applications, data associated with the operating system or the one or more applications, or other such data associated with the computing device 1302.

Other system memory 1314 can be available for use as well. The memory 1314 can include multiple different types of memory with different performance characteristics. The processor 1304 can include any general purpose processor and one or more hardware or software services, such as service 1312 stored in storage device 1310, configured to control the processor 1304 as well as a special-purpose processor where software instructions are incorporated into the actual processor design. The processor 1304 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1304 can be a microprocessor, a microcontroller, a digital signal processor (“DSP”), or a combination of these and/or other types of processors. In some embodiments, the processor 1304 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1300, an input device 1316 can represent any number of input mechanisms, such as a microphone for speech, a touch-sensitive screen for gesture or graphical input, keyboard, mouse, motion input, pen, and other such input devices. An output device 1318 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1300. In some embodiments, the input device 1316 and/or the output device 1318 can be coupled to the computing device 1302 using a remote connection device such as, for example, a communication interface such as the network interface 1320 described herein. In such embodiments, the communication interface can govern and manage the input and output received from the attached input device 1316 and/or output device 1318. As may be contemplated, there is no restriction on operating on any particular hardware arrangement and accordingly the basic features here may easily be substituted for other hardware, software, or firmware arrangements as they are developed.

In some embodiments, the storage device 1310 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1310 can include hardware and/or software services such as service 1312 that can control or configure the processor 1304 to perform one or more functions including, but not limited to, the methods, processes, functions, systems, and services described herein in various embodiments. In some embodiments, the hardware or software services can be implemented as modules. As illustrated in example computing system architecture 1300, the storage device 1310 can be connected to other parts of the computing device 1302 using the system connection 1306. In some embodiments, a hardware service or hardware module such as service 1312, that performs a function can include a software component stored in a non-transitory computer-readable medium that, in connection with the necessary hardware components, such as the processor 1304, connection 1306, cache 1308, storage device 1310, memory 1314, input device 1316, output device 1318, and so forth, can carry out the functions such as those described herein.

The disclosed systems and service of the hybrid optical-electronic system (e.g., the hybrid optical-electronic system described herein at least in connection with FIG. 1) can be performed using a computing system such as the example computing system illustrated in FIG. 13, using one or more components of the example computing system architecture 1300. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for performing multi-task image analyses associated with the hybrid optical-electronic system (e.g., the hybrid optical-electronic system described herein at least in connection with FIG. 1) described herein by, for example, executing code using a processor such as processor 1304 wherein the code is stored in memory such as memory 1314 as described herein. One or more of a user device, a provider server or system, a database system, or other such devices, services, or systems may include some or all of the components of the computing system such as the example computing system illustrated in FIG. 13, using one or more components of the example computing system architecture 1300 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1328. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1304 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1314 can be coupled to the processor 1304 by, for example, a connector such as connector 1306, or a bus. As used herein, a connector or bus such as connector 1306 is a communications system that transfers data between components within the computing device 1302 and may, in some embodiments, be used to transfer data between computing devices. The connector 1306 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1314 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1314 can also include magnetic or optical data storage media including read-only (e.g., CD ROM and DVD ROM) or otherwise (e.g., CD or DVD). The memory can be local, remote, or distributed.

As described above, the connector 1306 (or bus) can also couple the processor 1304 to the storage device 1310, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1310. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1306 can also couple the processor 1304 to a network interface device such as the network interface 1320. The interface can include one or more of a modem or other such network interfaces including, but not limited to those described herein. It will be appreciated that the network interface 1320 may be considered to be part of the computing device 1302 or may be separate from the computing device 1302. The network interface 1320 can include one or more of an analog modem, Integrated Services Digital Network (ISDN) modem, cable modem, token ring interface, satellite transmission interface, or other interfaces for coupling a computer system to other computer systems. In some embodiments, the network interface 1320 can include one or more input and/or output (I/O) devices. The I/O devices can include, by way of example but not limitation, input devices such as input device 1316 and/or output devices such as output device 1318. For example, the network interface 1320 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1302 can be connected to one or more additional computing devices such as computing device 1324 via a network 1322 using a connection such as the network interface 1320. In such embodiments, the computing device 1324 may execute one or more services 1326 to perform one or more functions under the control of, or on behalf of, programs and/or services operating on computing device 1302. In some embodiments, a computing device such as computing device 1324 may include one or more of the types of components as described in connection with computing device 1302 including, but not limited to, a processor such as processor 1304, a connection such as connection 1306, a cache such as cache 1308, a storage device such as storage device 1310, memory such as memory 1314, an input device such as input device 1316, and an output device such as output device 1318. In such embodiments, the computing device 1324 can carry out the functions such as those described herein in connection with computing device 1302. In some embodiments, the computing device 1302 can be connected to a plurality of computing devices such as computing device 1324, each of which may also be connected to a plurality of computing devices such as computing device 1324. Such an embodiment may be referred to herein as a distributed computing environment.

The network 1322 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1322 can be wired connections, wireless connections, or combinations thereof. Communications via the network 1322 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1322, within the computing device 1302, within the computing device 1324, or within the computing resources provider 1328 can include information, which also may be referred to herein as content. The information may include text, graphics, audio, video, haptics, and/or any other information that can be provided to a user of the computing device such as the computing device 1302. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1302 and presented to a user of the computing device 1302 using forms that are perceptible via sight, sound, smell, taste, touch, or other such mechanisms. In some embodiments, communications over the network 1322 can be received and/or processed by a computing device configured as a server. Such communications can be sent and received using PUP: Hypertext Preprocessor (“PHP”), Python™, Ruby, Perl® and variants, Java®, HTML, XML, or another such server-side processing language.

In some embodiments, the computing device 1302 and/or the computing device 1324 can be connected to a computing resources provider 1328 via the network 1322 using a network interface such as those described herein (e.g. network interface 1320). In such embodiments, one or more systems (e.g., service 1330 and service 1332) hosted within the computing resources provider 1328 (also referred to herein as within “a computing resources provider environment”) may execute one or more services to perform one or more functions under the control of, or on behalf of, programs and/or services operating on computing device 1302 and/or computing device 1324. Systems such as service 1330 and service 1332 may include one or more computing devices such as those described herein to execute computer code to perform the one or more functions under the control of, or on behalf of, programs and/or services operating on computing device 1302 and/or computing device 1324.

For example, the computing resources provider 1328 may provide a service, operating on service 1330 to store data for the computing device 1302 when, for example, the amount of data that the computing device 1302 exceeds the capacity of storage device 1310. In another example, the computing resources provider 1328 may provide a service to first instantiate a virtual machine (VM) on service 1332, use that VM to access the data stored on service 1332, perform one or more operations on that data, and provide a result of those one or more operations to the computing device 1302. Such operations (e.g., data storage and VM instantiation) may be referred to herein as operating “in the cloud,” “within a cloud computing environment,” or “within a hosted virtual machine environment,” and the computing resources provider 1328 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1328 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1330 and service 1332 may implement versions of various services (e.g., the service 1312 or the service 1326) on behalf of, or under the control of, computing device 1302 and/or computing device 1324. Such implemented versions of various services may involve one or more virtualization techniques so that, for example, it may appear to a user of computing device 1302 that the service 1312 is executing on the computing device 1302 when the service is executing on, for example, service 1330. As may also be contemplated, the various services operating within the computing resources provider 1328 environment may be distributed among various systems within the environment as well as partially distributed onto computing device 1324 and/or computing device 1302.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1302) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 1200 of FIG. 12). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1302.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A hybrid optical-electronic system for processing images and videos, the hybrid optical-electronic system comprising:
a meta-extractor configured to:
extract, using an optical metasurface comprising a plurality of meta-atoms, global-image features associated with an image, wherein the global-image features are extracted based on a first set of optical characteristics associated with the image, and wherein the first set of optical characteristics are captured based on a first diffraction distance between the optical metasurface and an image sensor and
extract, using the optical metasurface, local-region features associated a region of the image, wherein the local-region features are extracted based on a second set of optical characteristics associated with the region of the image, wherein the second set of optical characteristics are captured based on a second diffraction distance between the optical metasurface and the image sensor, and wherein the first diffraction distance is greater than the second diffraction distance;
an embedded device configured to:
access, using an image sensor, the global-image features of the image and the local-region features of the region of the image;
process the global-image features and the local-region features using an electronic neural network to generate a set of machine-learning outputs, wherein the electronic neural network: (i) fuses the global-image features and the local-region features into one or more feature vectors; and (ii) processes the one or more feature vectors to simultaneously perform different types of image-processing operations, thereby generating the set of machine-learning outputs; and
operate the embedded device based on the set of machine-learning outputs.

2. The hybrid optical-electronic system of claim 1, wherein the embedded device includes an autonomous piloting system for an automobile or an unmanned aerial vehicle (UAV), and wherein operating the embedded device includes performing autonomous piloting.

3. The hybrid optical-electronic system of claim 1, wherein the embedded device includes an Internet of Things (IoT) edge device, and wherein operating the embedded device includes detecting one or more objects depicted in the image.

4. The hybrid optical-electronic system of claim 1, wherein the optical metasurface is fabricated with phase and amplitude modulation coefficients that are in accordance with a Gaussian distribution.

5. The hybrid optical-electronic system of claim 1, wherein the image corresponds to a video frame of a plurality of video frames.

6. The hybrid optical-electronic system of claim 1, wherein extracting the local-region features includes:
generating multi-channel features of the image based on the second set of optical characteristics, wherein the multi-channel features include a plurality of individual-channel features, and wherein each individual-channel feature is captured using a subset of the plurality of meta-atoms of the optical metasurface; and
performing a linear combination of the multi-channel features to extract the local-region features of the image.

7. The hybrid optical-electronic system of claim 1, wherein the electronic neural network was trained to generate the set of machine-learning outputs without modifying geometrical characteristics of the plurality of meta-atoms of the optical metasurface.

8. A computer-implemented method comprising:
extracting, using an optical metasurface comprising a plurality of meta-atoms, global-image features associated with an image, wherein the global-image features are extracted based on a first set of optical characteristics associated with the image, and wherein the first set of optical characteristics are captured based on a first diffraction distance between the optical metasurface and an image sensor; and
extracting, using the optical metasurface, local-region features associated a region of the image, wherein the local-region features are extracted based on a second set of optical characteristics associated with the region of the image, wherein the second set of optical characteristics are captured based on a second diffraction distance between the optical metasurface and the image sensor, and wherein the first diffraction distance is greater than the second diffraction distance;
accessing, using an image sensor, the global-image features of the image and the local-region features of the region of the image;
processing the global-image features and the local-region features using an electronic neural network to generate a set of machine-learning outputs, wherein the electronic neural network: (i) fuses the global-image features and the local-region features into one or more feature vectors; and (ii) processes the one or more feature vectors to simultaneously perform different types of image-processing operations, thereby generating the set of machine-learning outputs; and
operating an embedded device based on the set of machine-learning outputs.

9. The computer-implemented method of claim 8, wherein the embedded device includes an autonomous piloting system for an automobile or an unmanned aerial vehicle (UAV), and wherein operating the embedded device includes performing autonomous piloting.

10. The computer-implemented method of claim 8, wherein the embedded device includes an Internet of Things (IoT) edge device, and wherein operating the embedded device includes detecting one or more objects depicted in the image.

11. The computer-implemented method of claim 8, wherein the optical metasurface is fabricated with phase and amplitude modulation coefficients that are in accordance with a Gaussian distribution.

12. The computer-implemented method of claim 8, wherein the image corresponds to a video frame of a plurality of video frames.

13. The computer-implemented method of claim 8, wherein extracting the local-region features includes:
generating multi-channel features of the image based on the second set of optical characteristics, wherein the multi-channel features include a plurality of individual-channel features, and wherein each individual-channel feature is captured using a subset of the plurality of meta-atoms of the optical metasurface; and
performing a linear combination of the multi-channel features to extract the local-region features of the image.

14. The computer-implemented method of claim 8, wherein the electronic neural network was trained to generate the set of machine-learning outputs without modifying geometrical characteristics of the plurality of meta-atoms of the optical metasurface.

15. A non-transitory, computer-readable storage medium storing thereon executable instructions that, as a result of being executed by one or more processors of a computer system, cause the computer system to perform operations comprising:
extracting, using an optical metasurface comprising a plurality of meta-atoms, global-image features associated with an image, wherein the global-image features are extracted based on a first set of optical characteristics associated with the image, and wherein the first set of optical characteristics are captured based on a first diffraction distance between the optical metasurface and an image sensor; and
extracting, using the optical metasurface, local-region features associated a region of the image, wherein the local-region features are extracted based on a second set of optical characteristics associated with the region of the image, wherein the second set of optical characteristics are captured based on a second diffraction distance between the optical metasurface and the image sensor, and wherein the first diffraction distance is greater than the second diffraction distance;
accessing, using an image sensor, the global-image features of the image and the local-region features of the region of the image;
processing the global-image features and the local-region features using an electronic neural network to generate a set of machine-learning outputs, wherein the electronic neural network: (i) fuses the global-image features and the local-region features into one or more feature vectors; and (ii) processes the one or more feature vectors to simultaneously perform different types of image-processing operations, thereby generating the set of machine-learning outputs; and
operating an embedded device based on the set of machine-learning outputs.

16. The non-transitory, computer-readable storage medium of claim 15, wherein the embedded device includes:
an autonomous piloting system for an automobile or an unmanned aerial vehicle (UAV), wherein operating the embedded device includes performing autonomous piloting; or
an Internet of Things (IoT) edge device, and wherein operating the embedded device includes detecting one or more objects depicted in the image.

17. The non-transitory, computer-readable storage medium of claim 15, wherein the optical metasurface is fabricated with phase and amplitude modulation coefficients that are in accordance with a Gaussian distribution.

18. The non-transitory, computer-readable storage medium of claim 15, wherein the image corresponds to a video frame of a plurality of video frames.

19. The non-transitory, computer-readable storage medium of claim 15, wherein extracting the local-region features includes:
generating multi-channel features of the image based on the second set of optical characteristics, wherein the multi-channel features include a plurality of individual-channel features, and wherein each individual-channel feature is captured using a subset of the plurality of meta-atoms of the optical metasurface; and
performing a linear combination of the multi-channel features to extract the local-region features of the image.

20. The non-transitory, computer-readable storage medium of claim 15, wherein the electronic neural network was trained to generate the set of machine-learning outputs without modifying geometrical characteristics of the plurality of meta-atoms of the optical metasurface.
